(19) United States
(12) Patent Application Publication
(10) Pub. No.: US 2026/0054291 A1
(43) Pub. Date: Feb. 26, 2026

(54) SYSTEM FOR ANALYSING AND SORTING A MATERIAL PART

(71) Applicant: HYDRO ALUMINIUM RECYCLING DEUTSCHLAND GMBH, Dormagen (DE)

(72) Inventors: Claudius LASKA, Königswinter (DE); Dennis WINTERSCHEID, Erftstadt (DE)

(21) Appl. No.: 19/104,549

(22) PCT Filed: Jul. 21, 2023
(86) PCT No.: PCT/EP2023/070260

§ 371 Date: Feb. 18, 2025

(30) Foreign Application Priority Data
Aug. 19, 2022 (DE) 20 2022 104 717.0
Aug. 19, 2022 (DE) 20 2022 104 718.9
Aug. 19, 2022 (EP) 22191285.0

(51) Int. Cl. B07C 5/02; B07C 5/342

(52) U.S. Cl. CPC B07C 5/02; B07C 5/342

(57) ABSTRACT

The invention relates to a system for analysing and sorting a material part, in particular a scrap part made of aluminium, comprising: a feed means (110) for transporting the material part (120), a sorting unit (160) that is designed to feed the material part (120) to one of two fractions (F1, F2); a laser device (140) that is designed to generate a plasma (3) on a surface (7A) of the material part (120), with a laser beam (5) propagating along a beam axis (5A); a spectrometer system (1) that is designed to perform a spectral analysis of a plasma light (3A) emitted from the laser-induced plasma (3) and to generate an output signal in accordance with a result of the spectral analysis performed; and a control device (150), that is designed to receive the output signal and to operate the sorting unit (160) on the basis of the output signal and a sorting criterion; wherein the spectrometer system (1) has a spectrometer (13) and a detection unit (21) optically connected to the spectrometer (13); wherein the detection unit (21) has a lens (25A, 25B, 25C, 25D) to which a detection cone (35) is assigned, which forms a plasma detection region (39) in an overlap region (37) with the laser beam (5); wherein the feed means (110) has three individual feed assemblies (201, 202, 203) arranged in series one after another in the transport direction (207) of the material part (120); wherein each feed assembly (201, 202, 203) is designed to transport the material part (120) along a feed surface (204, 205, 206) provided by the respective feed assembly (201, 202, 203), wherein the feed surfaces (204, 205, 206) are each inclined with respect to the horizontal to form a respective angle of inclination (α₁, α₂, α₃); wherein the angles of inclination (α₁, α₂, α₃) are formed differently; wherein the angle of inclination (α₁) of the feed surface (204) of the first feed assembly (201) in the transport direction (207) is smaller than the angle of inclination (α₂) of the feed surface (205) of the second feed assembly (202) in the transport direction (207); and wherein the angle of inclination (α₂) of the feed surface (205) of the second feed assembly (202) in the transport direction (207) is smaller than the angle of inclination (α₃) of the feed surface (206) of the third feed assembly (203) in the transport direction (207).

The invention relates to a system for analyzing and sorting a piece of material, in particular a scrap piece of aluminum, the system comprising:
a feed means for transporting the piece of material,
a sorting unit that is designed to feed the piece of material to one of two fractions,
a laser device that is designed to generate a plasma on a surface of the piece of material with a laser beam propagating along a beam axis,
a spectrometer system that is designed to perform a spectral analysis of a plasma light emitted by the laser-induced plasma and to generate an output signal in accordance with a result of the spectral analysis performed, and
a control device that is designed to receive the output signal and to operate the sorting unit based on the output signal and a sorting criterion,
wherein the spectrometer system comprises a spectrometer and a detection unit optically connected to the spectrometer,
wherein the detection unit comprises an objective having a detection cone assigned to it, which forms a plasma detection area in an overlap region with the laser beam,
wherein the feed means comprises three individual feeding units arranged in series one behind the other in the direction of transport of the piece of material,
wherein each feeding unit is configured to transport the piece of material along a feeding surface provided by the respective feeding unit,
wherein the feeding surfaces are each inclined at a respective angle of inclination with respect to the horizontal,
wherein the angles of inclination are different.

A system for analyzing and sorting a piece of material is known from EP 3 352 919 B1. The previously known system enables sorting of pieces of material, in particular scrap pieces of aluminum, based on laser-induced plasma spectroscopy, also referred to as LIBS (laser-induced breakdown spectroscopy). In this process, laser-induced plasma spectroscopy is used to determine the element-specific composition of a piece of material, i.e. a sample, with the aid of a plasma. The plasma is generated by high-intensity, focused laser radiation on a surface of the piece of material. Light emitted by the plasma is detected and spectrally analyzed to deduce the elemental composition of the piece of material.

Furthermore, a device for sorting waste material, in particular waste glass, according to its color using a vibrating bar screen, a separating device and an optoelectronic measuring and sorting device is known from DE 91 06 292 U.

A method and an apparatus for sorting waste into different types of waste are known from WO 90/11142 A1. The apparatus comprises a first conveyor, a second conveyor and a third conveyor as well as means for unloading, identification means, recording and control means and means for separating the waste.

According to a system known from EP 2 859 963 A1, an apparatus for sorting bulk material, in particular pellets, comprises a vibration conveyor system and a feeding means that supplies bulk material to the vibration conveyor system, a first outlet and a second outlet, a detector and a sorting device that influences the trajectory of bulk material recognized as being defective in such a way that this bulk material falls into the second outlet, wherein a rotationally driven roller adjoins the end of the vibration conveyor system, wherein the bulk material conveyed over the end of the vibration conveyor system arrives on the roller and the roller conveys the bulk material in the direction of the first outlet with a trajectory predetermined by rotation of the roller. It is suggested there that the at least one vibration conveyor system can comprise a plurality of vibration conveyors arranged one behind the other in the conveying direction of the bulk material. At least two of the plurality of vibration conveyors can be arranged at different angles with respect to the horizontal.

According to the system known from EP 3 352 919 B1, pieces of material to be sorted are fed to a feeding means. The feeding means may, for example, be vibratory plates that provide a feeding surface along which the pieces of material are moved.

The pieces of material to be analyzed and sorted are fed to a chute by means of the feeding means in accordance with EP 3 352 919 B1. Following the force of gravity, the pieces of material slide down the chute and leave it via a lower edge of the chute. From here, the pieces of material to be analyzed and sorted continue to move in free fall under the force of gravity through the ambient atmosphere. The feeding means and the chute serve to singulate the pieces of material and to move them in free fall through a spatially defined fall corridor.

During the free fall, a laser-induced plasma spectroscopy takes place for each piece of material leaving the chute. For this purpose, a laser device is provided that is configured to generate a plasma on a surface of a piece of material with a laser beam propagating along a beam axis. Furthermore, a spectrometer system is provided that is designed to perform a spectral analysis of the plasma light emitted by the laser-induced plasma and to generate an output signal in accordance with a result of the spectral analysis performed.

This output signal is then used in combination with a sorting criterion in a sorting unit to feed the pieces of material leaving the chute to one of two fractions. For example, an air nozzle can be used as a sorting unit, which is controlled accordingly by means of the control device. In this way, certain pieces of material can be sorted out from the stream of pieces of material leaving the chute under the effect of air pressure. As a result, there is one fraction of sorted pieces of material and one fraction of unsorted pieces of material.

Typically, the previously known system is used to discern pieces of material of a certain composition and to separate them from pieces of material of a different composition. Such a separation occurs either because a piece of material of an undesired composition is discerned and discharged by means of the sorting unit or because the composition of a piece of material could not be reliably determined and therefore a discharge by means of the sorting unit takes place. The fraction of the ejected pieces of material is composed of, on the one hand, pieces of material whose composition has been clearly identified and which are not wanted and, on the other hand, pieces of material whose composition has not been clearly identified.

Although the system described above has proven itself in everyday practical use, there is room for improvement. In particular, it has been found that, for an effective sorting result, it is crucial that the pieces of material to be sorted are fed to the laser device and/or the spectrometer system in a singulated form, so that the laser device and/or the spectrometer system can access them in an optimized manner as the process continues. Otherwise, the sorting result is adversely affected, in particular resulting in the disadvantageous sorting out of pieces of material that have not been clearly identified.

Therefore, based on prior art, the object of the invention is to further develop a system of the type mentioned at the beginning in terms of design to achieve increased sorting efficiency.

To achieve this object, a system of the type mentioned at the beginning is proposed, which is characterized in that
the angle of inclination of the feeding surface of the first feeding unit in the direction of transport is smaller than the angle of inclination of the feeding surface of the second feeding unit in the direction of transport and
the angle of inclination of the feeding surface of the second feeding unit in the direction of transport is smaller than the angle of inclination of the feeding surface of the third feeding unit in the direction of transport.

According to EP 3 352 919 B1, a feeding means is used to transport the piece of material, which feeding means provides a feeding surface along which the piece of material is moved in the intended use. The feeding means can, for example, be designed as a vibration plate. In particular, it serves to singulate a plurality of pieces of material fed onto the feeding means, so that they can then be fed to the laser device and/or the spectrometer system at a distance from one another.

However, the singulation achieved with the feed means known from EP 3 352 919 B1 is limited, which means that only a comparatively low throughput rate is possible. In this case, the throughput rate cannot simply be increased by feeding more pieces of material to be sorted to the feeding means, since in this case the singulation is insufficient, resulting in a decrease in sorting quality and thus in sorting efficiency. The design according to the invention provides a remedy here.

The feeding means comprises at least three feeding units. These are each designed as an independent assembly. Consequently, at least three separate, i.e. individual, feeding units are provided. These are arranged in series one behind the other in the direction of transport of the piece of material, whereby there is a first feeding unit in the direction of transport, a second feeding unit in the direction of transport and a third feeding unit in the direction of transport. These feeding units together form the feeding means according to the invention.

Each of the feeding units is designed to transport the piece of material along a feeding surface provided by the respective feeding unit. Each feeding unit therefore provides a feeding surface. In the intended use, the piece of material is conveyed in the direction of transport and passed from feeding unit to feeding unit.

The feeding surfaces of the feeding units are each inclined at a respective angle of inclination with respect to the horizontal. The feeding units or their feeding surfaces are therefore inclined at an angle to the horizontal in such a way that a piece of material is supported during its transport in the direction of transport due to the effect of gravity.

The feeding units each provide, for example, a plate that vibrates to provide the respective feeding surface. As a result of the vibratory movement of such a plate, a piece of material on it is transported in the direction of transport. The inclined alignment of the respective feeding surfaces, as provided for in the invention, supports this transport, since the force of gravity acting on the piece of material is added to the vibratory movement.

In this context, it is also provided that the angles of inclination of the feeding surfaces are designed to be different. As a result of the different angles of inclination, the force of gravity acting on the piece of material has a different influence on the transport of the piece of material in the direction of transport depending on the feeding unit. The influence is greater the greater the angle of inclination.

The different design of the angle of inclination also has the advantageous effect of accelerating a piece of material to a different extent in the direction of transport depending on the feeding unit. This in turn makes it possible to singulate a much larger number of pieces of material much more efficiently, even with a large number of pieces of material to be singulated. This is because the different angles of the feeding surfaces of the individual feeding units ensure that the transport speed of the pieces of material increases with increasing transport distance, which also increases the singulation efficiency with increasing transport distance. Consequently, the laser device and/or the spectrometer system can be reliably supplied with singulated pieces of material, even with an increase in the number of pieces of material to be separated compared to prior art. The feeding means according to the invention thus ensures an increased flow rate, while at the same time increasing the sorting quality, whereby the sorting efficiency of the system according to the invention is increased overall in comparison to prior art.

According to the invention, the angle of inclination of the feeding surface of the first feeding unit in the direction of transport of the piece of material is designed to be smaller than the angle of inclination of the feeding surface of the second feeding unit in the direction of transport of the piece of material. Due to gravity, the piece of material is accelerated to a higher transport speed by means of the second feeding unit. This leads to a singulation of the pieces of material, particularly in the longitudinal direction of the feeding unit, i.e. in the direction of transport of the piece of material.

The comparatively low transport speed, which is achieved by means of the first feeding unit, serves in particular to singulate the fed pieces of material in the width direction of the feeding unit, i.e. transversely to the direction of transport of the piece of material. This measure ensures homogenization of the pieces of material fed in the width direction, so that the sorting devices to be passed by the pieces of material in the further course of the process can be served equally. In particular, this advantageously avoids individual sorting units being fed too many pieces of material to achieve the desired sorting quality, while other sorting units provide unused processing capacity. Accordingly, the first feeding unit is used to distribute the pieces of material across the total available width of the feeding means.

The comparatively low speed of the pieces of material in the direction of transport, which is provided by the first feeding unit for the purpose of a widthwise distribution of the pieces of material, causes a certain accumulation of the pieces of material in the direction of transport. This accumulation is cleared after the pieces of material have been transferred from the first feeding unit to the second feeding unit, since the second feeding unit is inclined at a greater angle than the first feeding unit. This causes the pieces of material fed onto the second feeding unit to be singulated in the longitudinal direction, i.e. in the direction of transport of the pieces of material.

According to the invention, it is also provided that the angle of inclination of the feeding surface of the second feeding unit in the direction of transport of the piece of material is smaller than the angle of inclination of the feeding surface of the third feeding unit in the direction of transport of the piece of material.

Due to the even steeper inclination of the third feeding unit compared to the second feeding unit, further acceleration of the pieces of material in the direction of transport is achieved. The pieces of material already pre-singulated in the direction of transport by means of the second feed become even more distant in the direction of transport by means of the third feeding unit, and thus singulated. This second stage of singulation in the longitudinal direction enables a higher number of pieces of material to be processed by the feeding means compared to prior art. In this process, a singulation in the width direction takes place by means of the first feeding unit, and a singulation in the longitudinal direction is carried out by means of the two additional feeding units, with the result that singulated pieces of material are fed in the lengthwise direction across the entire width of the feeding means on the output side of the laser device or the spectrometer system. This enables spectroscopy in accordance with the intended purpose, and in contrast to prior art, at an increased flow rate.

According to a further feature of the invention, it is provided that the difference between the angles of inclination is 2° to 8°, preferably 3° to 7°, most preferably 5°.

As studies have shown, the individual angles of inclination cannot be chosen completely freely. On the one hand, the angles must be steep enough to allow an acceleration of the pieces of material following the force of gravity, in particular in the longitudinal direction of the parts, for the purpose of singulating them. On the other hand, however, the angles must not be chosen too steeply either, because this causes material to step over and/or leads to overtaking effects, which contradicts the desired singulation. The above-mentioned angle ranges are optimal according to the applicant's studies, whereby in particular a difference between the angles of inclination of 5° is chosen.

According to a further feature of the invention, it is provided that the angle of inclination of the feeding surface of the first feeding unit in the direction of transport of the piece of material is 7° to 13°, preferably 8° to 12°, most preferably 10°. This angle selection ensures that the pieces of material supplied to the feeding unit are sufficiently accelerated in the direction of transport, but at the same time the desired distribution of the pieces of material in the width direction still occurs. An angle of inclination that is too steep would have the disadvantageous effect of preventing the desired distribution of the pieces of material in the width direction.

According to a further feature of the invention, it is provided that the angle of inclination of the feeding surface of the second feeding unit in the direction of transport of the piece of material is 12° to 18°, preferably 13° to 17°, most preferably 15°.

After the pieces of material have been transferred from the first feeding unit to the second feeding unit, the pieces of material are accelerated in the direction of transport for the purpose of singulating the pieces of material in the longitudinal direction of the feeding unit, i.e. in the direction of transport. In a first step, it is important to carry out a pre-singulation of the pieces of material, while avoiding, in particular, overtaking effects. An angle of inclination of 10° has proved to be particularly suitable for achieving this desirable singulation. An even steeper angle would not lead to greater singulation, but on the contrary to partial unwanted material accumulations, in particular due to pieces of material which climb over and/or due to overtaking effects.

According to a further feature of the invention, it is provided that the angle of inclination of the feeding surface of the third feeding unit in the direction of transport of the piece of material is 17° to 23°, preferably 18° to 22°, most preferably 20°.

The pieces of material pre-singulated by means of the second feeding unit can now be singulated even further by means of the third feeding unit. In this case, the further inclination with respect to the third feeding unit is also possible while avoiding material to climb over and/or overtaking effects because the pieces of material are already pre-accelerated by means of the second feeding unit. The third feeding unit also serves to further singulate the pieces of material, so that ultimately, pieces of material that are spaced apart in a defined manner leave the feeding means in the direction of the laser device and/or the spectrometer system.

In contrast to prior art, the three-stage design of the feeding means according to the invention allows, on the one hand, an increased amount of material pieces to be processed, while, on the other hand, ensuring uniform distribution in the width direction and singulation in the direction of transport. In this process, the individual stages are coordinated with one another in terms of their respective angles of inclination in such a way that the pieces of material to be singulated are further accelerated from stage to stage, i.e. from feeding unit to feeding unit, whereby undesired overtaking effects and/or pieces of material that climb over are reliably avoided.

According to a further feature of the invention, it is provided that the angles of inclination are designed to be adjustable. The adjustability of the angle of inclination is particularly advantageous when pieces of material of different size and weight are to be sorted. This is because it is particularly useful to be able to adjust the respective angle of inclination in an optimized manner with regard to the sorting task. In this way, the angles of inclination of all or even just individual feeding units can be set accordingly, depending in particular on the size of the pieces of material to be sorted and/or their specific weight.

According to a further feature of the invention, it is provided that the first feeding unit in the direction of transport of the piece of material is an oscillating conveyor with an unbalanced drive.

The first feeding unit in the direction of transport is used to singulate the pieces of material and distribute them in the width direction. An oscillating conveyor with an unbalanced drive is sufficient for this purpose, making it the preferred option due to its comparatively low acquisition and maintenance costs.

The second and third feeding units are preferably designed as oscillating conveyors with a magnetic drive, in accordance with a further feature of the invention. In contrast to an oscillating feeding means with an unbalanced drive, an oscillating feeding means with a magnetic drive offers the advantage of being able to be dosed continuously, which means that a more precise influence can be exerted on the conveying speed in the direction of transport. The magnetic drive also ensures that any follow-up movement of pieces of material is basically excluded. This allows for very precise control of the material transport, which means that targeted influence can be exerted on the desired singulation of the pieces of material.

According to a further feature of the invention, it is provided that the detection unit includes a further objective, with which a further detection cone assigned to it, which forms a further plasma detection area in a further overlap region with the laser beam, wherein the objectives are arranged and/or aligned in relation to one another in such a way that the plasma detection area and the further plasma detection area are arranged offset along the beam axis and together form a viewing area of the detection unit.

This design advantageously provides an enlarged detection area, with the result that more pieces of material can be reliably detected with regard to their composition. Consequently, the sorting result is improved because false sorting is minimized. The result is a more effective sorting process.

The enlarged detection area is achieved by the fact that, in contrast to prior art, not only one objective is provided, but several objectives, i.e. at least two objectives. However, more than two objectives are preferred, for example three, four or even more objectives. A plasma detection area is set for each objective. Accordingly, with four objectives, there are four plasma detection areas. According to the invention, it is further provided that the objectives are arranged and/or aligned in relation to one another in such a way that the plasma detection areas are arranged offset along the beam axis of the laser beam and together form the viewing area of the detection unit. In this case, the viewing area represents the overall detection area that is composed of the individual plasma detection areas and is therefore significantly larger than in prior art.

According to the prior art, the detection area is formed by only one plasma detection area of an objective. Along the beam axis of the laser beam, such a plasma detection area can typically extend over a distance of 8 to 10 mm. The composition of the viewing area of the detection unit according to the invention, consisting of individual plasma detection areas arranged in an offset manner along the beam axis, results in an overall detection area that extends over 20 mm, 30 mm, 40 mm or more in the direction of the beam axis. This has the advantageous effect that, due to their geometric design, otherwise undetectable pieces of material can be reliably detected, including, in particular, spherically or partially spherically shaped pieces of material.

As a result, the system according to the invention allows for improved sorting, since the proportion of sorted-out pieces of material that are sorted out because their composition cannot be reliably identified is minimized.

The design of the feeding means according to the invention on the one hand and the equipping of the detection unit with a further objective on the other hand result in the synergetic effect of an overall increase in throughput. Although the feeding means according to the invention may process more pieces of material than prior art, a detection unit adapted to this is also required. On the other hand, a detection unit equipped with an additional objective is not fully utilized if the feeding means is not able to provide a corresponding quantity of pieces of material in a singulated manner. The feeding means designed according to the invention on the one hand and the further developed detection unit on the other hand thus ensure in combination an even further increased flow rate overall.

According to a further feature of the invention, it is provided that a plasma detection area is configured in such a way that, in the event of a plasma being present in the plasma detection area, a measurement component of the plasma light is detected by the associated objective. Thus, if a laser-induced plasma is located, at least partially, in a plasma area, a measurement component of the emitted plasma light is detected by the associated objective. If, according to the invention, there are several objectives, this means that the detection unit can detect plasma light in the form of measurement components of individual objectives.

According to a further feature of the invention, it is provided that the plasma detection areas along the beam axis are arranged so as to merge into one another or be spaced apart. Alternatively or additionally, the plasma detection areas can each extend over 1/10 to ¼ of the viewing area along the beam axis. It is therefore possible, in particular after the sorting task, to form an overall detection region by arranging the plasma detection areas accordingly.

According to a further feature of the invention, it is provided that the feeding means according to the invention is configured to transport the piece of material along a feeding surface up to an upper section of a chute. According to this preferred embodiment, the piece of material is fed to the feeding means. From there, it passes to a chute, being transported along a feeding surface of the feeding means, as far as an upper section of the chute. Once the piece of material has reached the chute, it moves down the chute under the force of gravity. The purpose of the chute is, in particular, to align the piece of material and to transfer it into a defined fall corridor.

According to a further feature of the invention, it is provided that the sorting unit is associated with a lower edge of the chute opposite the upper portion of the chute, wherein the sorting unit is adapted to direct the piece of material leaving the chute via the lower edge to one of two fractions.

According to this preferred embodiment, a piece of material leaves the chute in free fall and is subjected to analysis and sorting in free fall. For this purpose, in particular the laser device as well as the spectrometer system are arranged in the height direction below the lower edge of the chute.

According to a further feature of the invention, it is provided that the detection unit carries a protective housing that surrounds the laser beam and the detection cone.

A protective housing is provided that protects both the laser beam and the detection cone of the objective from unwanted dust or particle entry from the outside. This effectively minimizes dust-related fluctuations in sorting efficiency, ensuring that the sorting efficiency remains at least the same over time.

The protective housing surrounds the laser beam and the detection cone. The laser beam and the detection cone are thus guided through a volume space provided by the protective housing. Thanks to the encapsulation provided by the protective housing, this volume space is largely free of foreign particles, in particular dust particles and/or similar contaminants, so that neither the laser beam nor the detection cone are impaired in their functionality. Furthermore, the protective housing advantageously ensures that dust or other foreign particles cannot accumulate unintentionally, especially on the optics, thus minimizing the risk of a lens defect caused by such particles burning into it.

Thus, on the one hand, the protective housing ensures that the inner space volume provided by the protective housing and traversed by both the laser beam and the detection cone is kept largely free of dust or similar foreign particles and, on the other hand, it ensures that dust or other foreign particles do not accumulate on the optics or clog the passage opening. As a result, a sorting efficiency that is at least constant over time, if not even increased, is ensured, and this in a constructively simple and thus cost-effective way.

According to a further feature of the invention, it is provided that the protective housing extends along the beam axis of the laser beam. The protective housing is arranged on the detection unit, is therefore supported by it and extends from the detection unit in the direction of the longitudinal axis of the laser beam and thus along the beam axis. The laser beam and thus also the detection area of the objective are enclosed by the protective housing that provides a secure shield for both the objective and the passage for the laser beam against dust or other foreign particles.

According to a further feature of the invention, it is provided that the protective housing extends over part of the distance between the detection unit and the plasma detection area.

The plasma detection area is located outside the protective housing. Otherwise, proper material detection would not be possible. In order to guide both the laser beam and the detection cones to the plasma detection area with as little dust or foreign particles as possible, the protective housing extends over at least part of the distance between the detection unit and the plasma detection area. However, the protective housing preferably extends as far as the plasma detection area, so that the entire section between the detection unit and the plasma detection area is covered by the protective housing as far as possible.

According to a further feature of the invention, it is provided that the protective housing is a frustoconical pipe section. The protective housing is therefore designed as a pipe that tapers on the plasma detection side. This tapering has two advantageous effects. Firstly, the protective housing is large enough on the detection unit side to fully accommodate the optics provided by the detection unit on the one hand and the passage opening for the laser provided by the detection unit on the other. The entire optics and the passage opening are therefore covered by the protective housing and thus protected from unwanted external influences.

As a result of the tapering of the protective housing in the direction of the plasma detection area, an outlet opening is provided that is as small as possible, but still large enough for the laser beam and the detection cone to form in the plasma detection area in the desired way, i.e. not to be affected by the protective housing. In this case, the outlet cross-section of the protective housing is to be designed as small as possible in order to minimize unwanted dust or foreign particle entry through the outlet opening into the protective housing. In this context, it is preferred that the outlet opening has a diameter of 9 mm to 13 mm, preferably of 10 mm to 12 mm, even more preferably of 11 mm.

According to a further feature of the invention, it is provided that the protective housing is connected to a compressed air supply on the laser beam entry side.

The compressed air supply makes it possible to flood the protective housing with air and to pass air through it. In this process, the air is supplied to the protective housing on the laser beam inlet side so that the air passes through the protective housing in the direction of laser beam propagation and leaves the same via the outlet opening.

The air flushing of the protective housing has two main advantages. Firstly, the protective housing is kept completely free of unwanted dust or foreign particles, as any dust or other foreign particles that could enter the protective housing via the outlet opening are blown out by compressed air. On the other hand, an air column forms around the laser beam on the outlet side. This means that the plasma detection area can also be kept free of dust or other foreign particles, so that the laser beam can be used to access the pieces of material to be sorted without any dust particles. This optimizes laser detection, which further increases the sorting efficiency of the system according to the invention.

According to a further feature of the invention, the protective housing is formed from a material that provides an inner surface that largely reduces reflection. In particular, plastic is a suitable material, which, unlike metal, does not provide a shiny surface. Any stray light penetrating the protective housing from the outside is absorbed to the greatest extent possible, enabling optimized lens utilization since no stray light effects impair lens operation.

According to a further feature of the invention, it is proposed in this context that the inner surface of the protective housing be roughened. The roughening ensures that any stray light effects that may occur lead to a diffuse reflection, which helps to maximize the light absorption rate. Both the choice of material and the design of the inner surface can therefore advantageously ensure that an additional increase in efficiency is achieved by avoiding any impairment of the optics by stray light. The protective housing according to the invention thus provides two effects in a synergetic way. On the one hand, the influence of dust or other foreign particles is minimized and, on the other hand, the optics are shielded from stray light. As a result of the design according to the invention, not only can a consistent sorting efficiency and quality be ensured over time, but in contrast to prior art, there is also an increase in sorting efficiency and quality. Therefore, in contrast to prior art, the system according to the invention allows for an increased throughput.

According to a further feature of the invention, it is provided that the sorting unit has a compressed air nozzle with an outlet opening of more than 3 mm, the compressed air nozzle being arranged at a distance from a laser beam generated by the laser device in the direction of movement of a piece of material passing through the laser beam, the distance between the laser beam and the center of the outlet opening of the compressed air nozzle being less than 10 mm.

The compressed air nozzle of the sorting device is used to implement a piece of material recognition carried out by the detection unit in that a pressure is applied to identified pieces of material by means of the dosing unit and the identified pieces of material are ejected as a result of this pressure application. A compressed air nozzle used according to the prior art typically has an outlet opening diameter of 3 mm. The invention now proposes to choose a significantly larger outlet diameter, in any case larger than 3 mm.

Furthermore, the invention provides that the distance between the compressed air nozzle and the laser beam is reduced in contrast to prior art and is less than 10 cm. According to the art, the distance between the laser beam and the compressed air nozzle is typically 10 cm or more.

In the combination of the enlarged outlet opening diameter, on the one hand, and the enlarged distance between the laser beam and the compressed air nozzle, on the other hand, in contrast to prior art, an increased throughput of pieces of material to be sorted is advantageously achieved.

At a typical falling speed of the pieces of material to be sorted and a nozzle opening time of 30 ms as provided by prior art, the pieces of material to be sorted must be fed to the sorting unit at a distance of at least 9 cm in order for optimized sorting to take place. As soon as the distances between the individual pieces of material shorten and are less than 9 cm, individual pieces of material can no longer be hit cleanly by the compressed air nozzle, which results in reduced sorting quality.

The design according to the invention provides a remedy here. On the one hand, it is provided according to the invention to shorten the distance between the laser beam on the one hand and the compressed air nozzle on the other, that is to say the distance between the laser beam and the center of the outlet opening of the compressed air nozzle, in contrast to prior art, and to select a distance of less than 10 cm. This reduction in distance ensures that the pieces of material in free fall towards the laser beam can less approach one another, which in turn makes it possible to provide for the pieces of material to be singulated at a reduced distance. Since the distance of fall is minimized due to the distance shortening, there is also a shorter fall time, so that the distance keeping accompanying a preceding singulation is not significantly altered, not even by a free fall in the direction of the laser device. Consequently, the distance keeping selected by a singulation of the pieces of material can be shortened, which allows a higher throughput.

Since the distance between individual pieces of material caused by the singulation can be shortened in the manner already described, a shorter switching time with regard to the compressed air nozzle is also possible. This in turn makes it possible to enlarge the outlet opening diameter in contrast to prior art, so that a larger effective range is created by means of the compressed air nozzle. However, different from prior art, this increased effective range does not result in neighboring pieces of material that are not supposed to be ejected also being ejected when compressed air is applied because, in contrast to prior art, the switching time of the compressed air nozzle can be reduced due to the reduction in distance. However, enlarging the outlet opening diameter enables a more secure detection and thus ejection of piece of material to be ejected, so that in combination with the two features according to the invention, the synergetic effect results in both an improved ejection quality on the one hand and an increased throughput on the other. As a result, in contrast to prior art, the sorting efficiency can be significantly increased.

According to prior art, it has been assumed so far that the outlet opening diameter of the compressed air nozzle should be chosen as small as possible, namely 3 mm and smaller. This is to ensure that only pieces of material to be ejected are subjected to compressed air and not, for example, pieces of material adjacent to the piece of material to be ejected. It has not been recognized that the outlet diameter of the compressed air nozzle and the distance between the compressed air nozzle and the laser beam are related in such a way that increasing the outlet diameter of the compressed air nozzle makes it possible to reduce the distance between the laser beam and the compressed air nozzle. This is because a reduced distance between the compressed air nozzle and the laser beam can minimize catch-up and/or overtaking effects with regard to the pieces of material in free fall, so that despite the enlarged outlet opening diameter, there is no risk of capturing pieces of material adjacent to a piece of material to be ejected. The enlarged outlet diameter, however, makes it possible to more reliably capture pieces of material to be ejected, so that, in combination with the shortened distance between the compressed air nozzle and the laser beam, there is an increased throughput rate and improved sorting quality in contrast to prior art.

According to a further feature of the invention, it is provided that the outlet opening diameter is 5 mm to 8 mm, preferably 6 mm to 7 mm, most preferably 6.5 mm.

As the applicant's studies have shown, the outlet opening diameter can be selected to be significantly larger than 3 mm. The size of the outlet opening diameter is to be optimized as a function of the distance between the compressed air nozzle and the laser beam on the one hand and as a function of the pieces of material to be sorted on the other. In this context, an outlet opening diameter of 6 mm to 7 mm is particularly preferred.

According to a further feature of the invention, it is provided that the distance between the laser beam and the center of the outlet opening of the compressed air nozzle is 8 cm to 3 cm, preferably 6 cm to 3.5 cm, even more preferably 5 cm to 4 cm, most preferably 4.5 cm.

The reduction of the distance between the laser beam and the center of the outlet opening of the compressed air nozzle, which is provided in contrast to prior art, yields the advantages already mentioned. In this context, the applicant's studies have shown that, with a correspondingly selected outlet opening diameter of the compressed air nozzle, it is possible to significantly reduce this distance in contrast to prior art. The shorter the distance between the laser beam and the compressed air nozzle, the less likely it is that pieces of material in free fall towards the laser beam will be caught up or overtake one another. If the pieces of material are sufficiently singulated, the distance between two successive pieces of material is such that, when compressed air is applied to the compressed air nozzle to eject one piece of material, neighboring pieces of material of the piece of material to be ejected are not also caught. As a consequence, the sorting quality is improved, since it is in particular prevented that pieces of material are erroneously ejected despite unambiguous identification.

According to a further feature of the invention, it is provided that the sorting unit comprises a solenoid valve cooperating with the compressed air nozzle, wherein the compressed air nozzle and the solenoid valve are arranged constructionally separate from each other.

The constructional separation of the compressed air nozzle and the solenoid valve makes it possible to optimize the use of the space available in the immediate vicinity of the laser device in such a way that the distance between the compressed air nozzle and the laser beam generated by the laser device in the intended use is created as small as possible. The spatial separation of the compressed air nozzle and the solenoid valve also has the advantage that the space available in the immediate vicinity of the laser device is not unnecessarily wasted by also accommodating the solenoid valve. Rather, this space remains free in order to be able to optimally align the compressed air nozzle at its distance from the laser device.

According to a further feature of the invention, it is provided that the compressed air nozzle is in fluidic connection with the solenoid valve by means of a compressed air line. The otherwise usual direct fluidic connection between the compressed air nozzle and the solenoid valve is replaced, according to this proposal of the invention, by a compressed air line, which may, for example, be designed as a hose. This makes it possible to constructionally separate the compressed air nozzle and the solenoid valve, without impairing the intended functionality of the compressed air nozzle.

According to a further feature of the invention, it is provided that the switching time of the solenoid valve is less than 30 ms, preferably less than 20 ms, even more preferably less than 10 ms.

This reduced switching time, in contrast to prior art, is made possible by the design according to the invention and results in a significantly higher throughput. Thus, twice the amount, or even three times the amount, of pieces of material can be sorted as intended per unit of time.

Further features and advantages of the invention will become apparent from the following description with reference to the attached drawing figures.

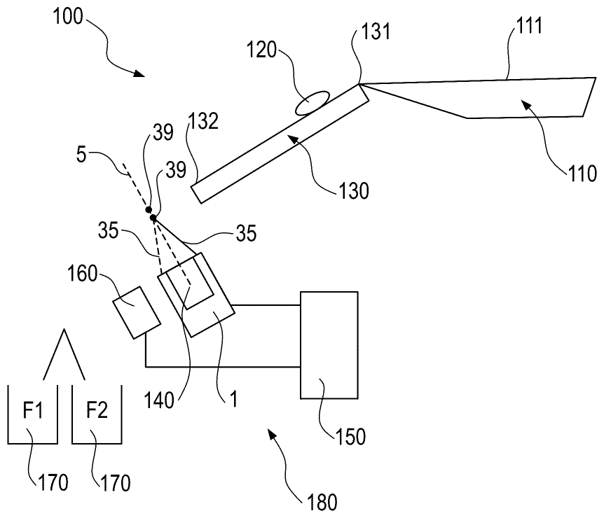

FIG. 1 schematically represents the system according to the invention;

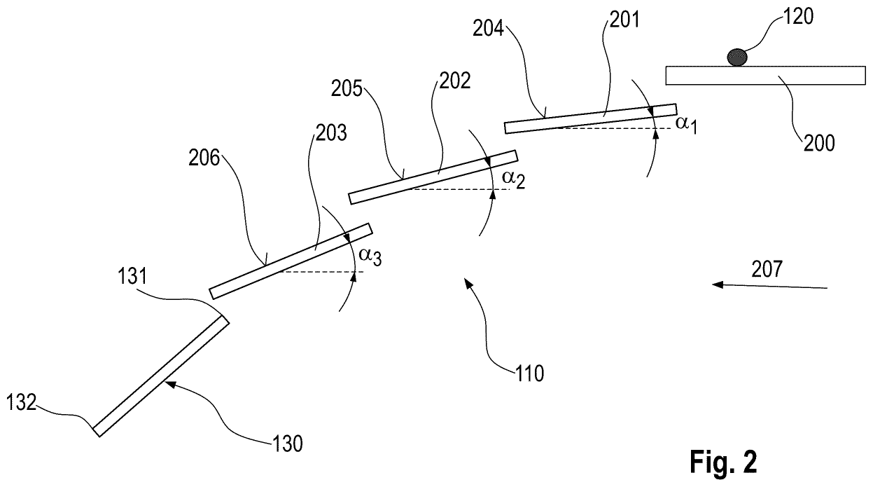

FIG. 2 schematically represents a feeding means according to the invention;

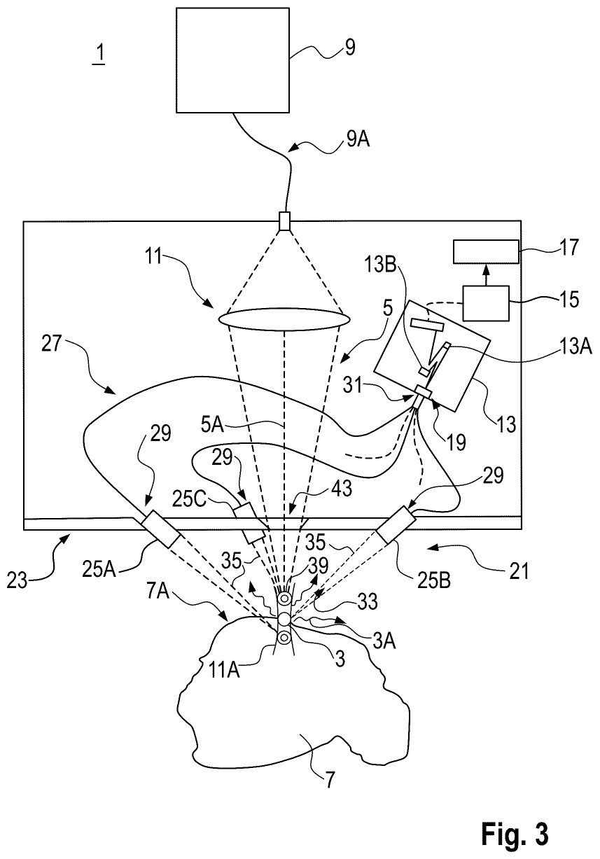

FIG. 3 is a further schematic representation the operation of the system according to the invention;

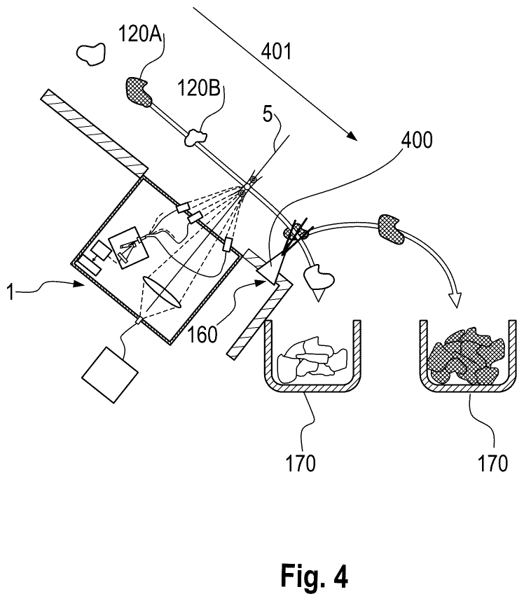

FIG. 4 is an enlarged schematic representation the spectrometer system according to the system according to the invention as shown in FIG. 1;

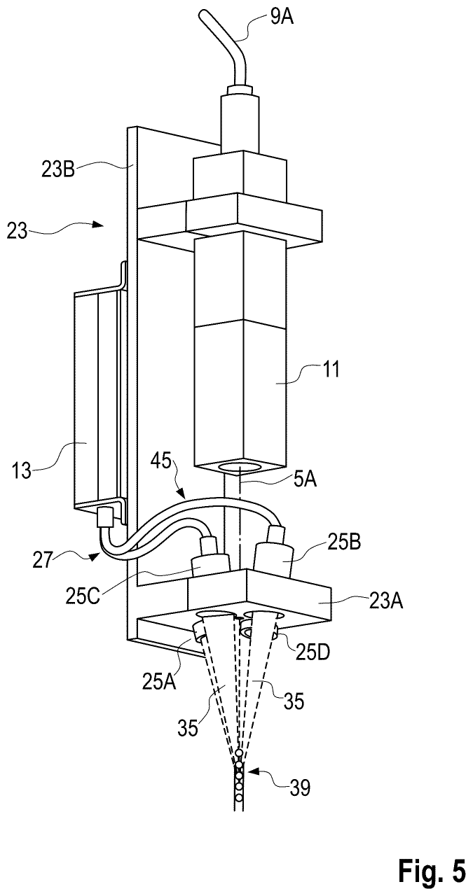

FIG. 5 is a further schematic representation the functioning of a LIBS module of the system according to the invention;

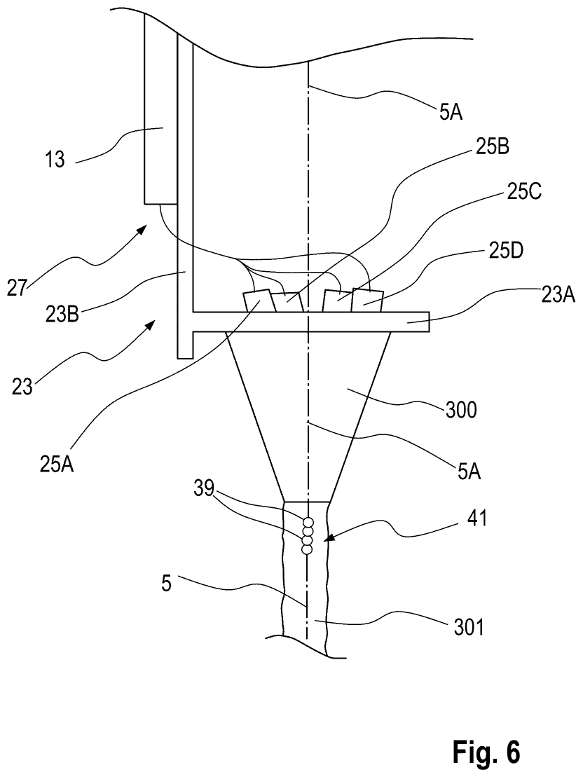

FIG. 6 is a schematic side view of a section of the module according to FIG. 5;

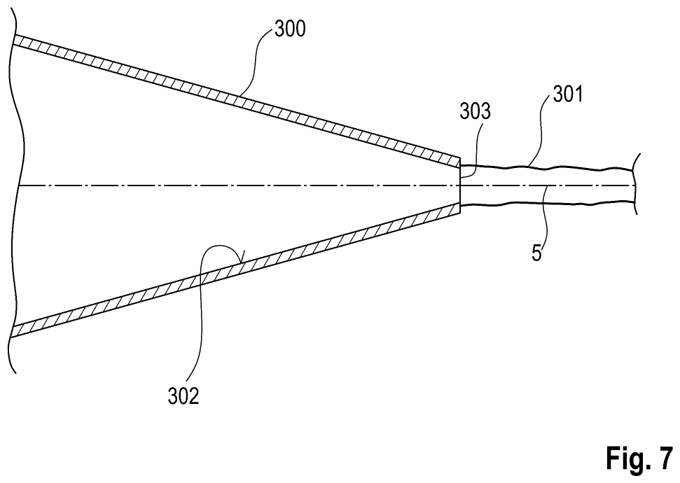

FIG. 7 is a partially cut side view of a protective housing according to the invention, and

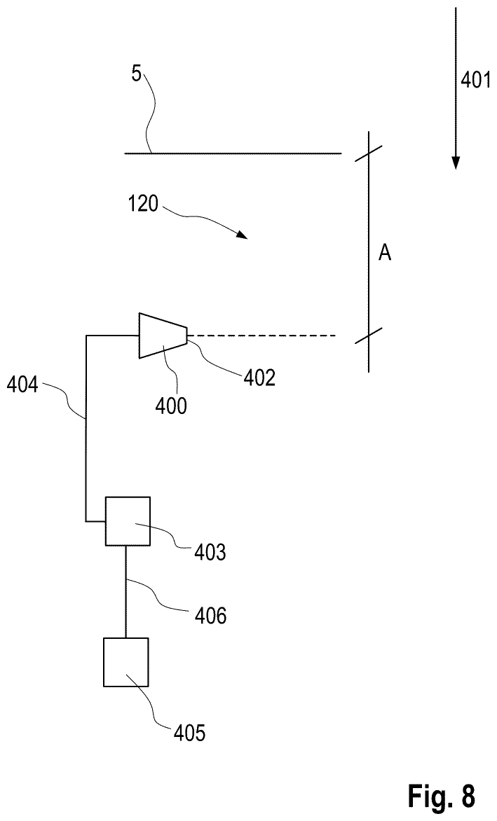

FIG. 8 schematically represents a compressed air nozzle designed and arranged according to the invention.

FIG. 1 schematically represents the system 100 according to the invention.

The system 100 is configured to subject a piece of material 120 to laser-induced plasma spectroscopy and to sort it depending on the result of the spectral analysis, wherein in the illustrated example, two fractions F1 and F2 are provided to which the piece of material 120 can be assigned. Collection points 170, for example in the form of bins, serve to receive the respective fractions F1 and F2.

As can be seen from the schematic representation according to FIG. 1, the system 100 has a feeding means 110 followed by a chute 130. In the intended use, a piece of material 120 is fed to the feeding means 110. The feeding means 110 serves to transport the piece of material 120 along a feeding surface 111 provided by the feeding means, namely up to an upper section 131 of the chute 130. Here the piece of material 120 is transferred from the feeding means 110 to the chute 130.

The feeding means 110 is used in particular to singulate a plurality of pieces of material 120 that have been placed on the feeding means 110, so that they can be fed to the chute 130 at a distance from one another.

A piece of material 120 transferred to the chute 130 slides down the chute 130 under the force of gravity to the lower edge 132 of the chute, which lower edge is designed to be opposite the upper section 131 of the chute 130. It is the task of the chute 130 in particular to align the piece of material 120 and to transfer it into a defined fall corridor.

Upon leaving the chute 130, the piece of material 120 continues to move under the effect of gravity in free fall through the surrounding atmosphere. In doing so, it passes the spectrometer system 1. This ensures an analysis of the piece of material 120, as will be described in more detail below. In accordance with the result of a spectral analysis carried out, the spectrometer system 1 generates an output signal. This is supplied to a control device 150 which operates, i.e. drives, a sorting unit 160 depending on this output signal on the one hand and a sorting criterion on the other. By means of this sorting unit 160, the piece of material 120 is either deflected in its free fall or no deflection takes place. If no deflection takes place, the piece of material 120 arrives at the collection point 170 for fraction F2. Otherwise, if sorting by means of the sorting unit 160 takes place, the piece of material 120 arrives at the collection point 170 for fraction F1.

The spectrometer system 1, which is part of a LIBS module 180, is used to analyze the composition of the piece of material 120. The LIBS module 180 also includes a laser device 140 and the control device 150. Preferably, the laser device 140, the spectrometer system 1 and the control device 150 are accommodated in a common housing, which is not shown in detail in FIG. 1.

The laser device 140 itself consists of further individual components, for example a laser beam source 9, an optical fiber 9A and focusing optics 11, as can be seen in particular from the example shown in FIG. 2.

The feeding means 110 is designed in three stages according to the invention, as can be seen from the illustration in FIG. 2.

In the example shown, the feeding means 110 has three separate feeding units 201, 202 and 203. These feeding units are arranged in series one behind the other in the direction of transport 207 of the piece of material 120. Each feeding unit 201, 202 and 203 provides a feeding surface 204, 205 and 206, respectively, along which a piece of material 120 is moved in the intended use.

The feeding surfaces 204, 205 and 206 are each inclined at a respective angle of inclination α₁, α₂ and α₃ to the horizontal. The angles of inclination α₁, α₂ and α₃ are designed to be different in size according to the invention.

In their entirety, the feeding units 201, 202 and 203 form the feeding means 110. The feeding surface 111 provided by the feeding means 110 is subdivided into the feeding surfaces 204, 205 and 206 of the feeding units 201, 202 and 203.

In the intended use, the feeding means 110 is fed 120 pieces of material, for example by means of a conveyor 200, which may be designed as a belt conveyor.

From the conveyor 200, the pieces of material 120 first reach the first feeding unit 201 in the direction of transport 207. This feeding unit 201 is designed, for example, as a vibratory conveyor with an unbalance drive and is used primarily to distribute the fed pieces of material 120 in the width direction, i.e. transversely to the direction of transport 207.

The feeding surface 204 of the first feeding unit 201 is inclined at an angle of inclination α₁ of, for example, 10°. As a result, the pieces of material are transported in the direction of transport 207 by gravity.

The pieces of material then move from the first feeding unit 201 to the second feeding unit 202 that is arranged downstream of the first feeding unit 201 in the direction of transport 207. The feeding surface 205 provided by the second feeding unit 202 is at an angle of inclination α₂, which is greater than the angle of inclination di and is, for example, 15°. This steeper angle of inclination α₂ ensures that a higher transport speed of the pieces of material 120 in the direction of transport 207 is achieved by gravity. As a result, the pieces of material 120 are singulated in the direction of transport 207.

From the second feeding unit 202, the pieces of material 120 finally reach the third feeding unit 203, whose feeding surface 206 is inclined at the angle of inclination as to the horizontal. The angle of inclination as is greater than the angle of inclination α₂ of the second feeding surface 205 and is, for example, 20°. This even steeper angle of inclination α₃ causes a further acceleration of the pieces of material 120, which leads to an even higher speed of the pieces of material 120 with the result that an even further singulation takes place in the direction of transport 207.

Finally, the pieces of material 120 are singulated in such a way in the direction of transport 207 that, after passing the feeding unit 203, they enter the chute 130, so that sorting can then take place in the manner already described.

As can be seen in particular from FIG. 3, the spectrometer system 1 has a detection unit 21, which in turn provides several objectives. A detection cone 35 is assigned to each of these objectives, which in an area of overlap with the laser beam 5 in each case form a plasma detection area 39. These plasma detection areas 39 are arranged offset to one another along the beam axis of the laser beam 5 and together form a viewing region 41 of the detection unit 21. The viewing region 41 is therefore composed of the individual plasma detection areas 39, whereby the detection area covered overall by the detection unit is defined.

FIG. 3 shows a schematic overview of a spectrometer system 1 for spectral analysis of a plasma light 3A emitted by a laser-induced plasma 3 (schematically indicated as a filled circle). Detectable plasma light 3A is, for example, in the wavelength range of UV light, visible light, near infrared light and/or infrared light; in particular, detectable plasma light can be in the spectral range of approximately 190 nm to approximately 920 nm. In the case of LIBS, the plasma 3 is generated by means of a laser beam 5 on a surface 7A of a sample 7.

In order to generate the, for example, pulsed laser beam 5, the spectrometer system 1 comprises a laser beam source 9. The laser beam source 9 is designed to provide laser beam parameters required for plasma generation. The laser beam 5 is supplied, for example, via an optical fiber 9A of focusing optics 11 and focused by the latter onto the surface 7A of the sample 7 (piece of material 120 according to FIG. 1). The focusing optics 11 can be designed in particular as a laser head component with a focusing function, such as an active laser component with a focusing function acting in particular on the spectrum or the pulse duration or the pulse energy. The laser beam 5 propagates between the focusing optics 11 and the sample 7 along a beam axis 5A. Exemplary focus diameters (1/e² beam diameter at the beam waist) and focus lengths (double Rayleigh lengths) are in the range from <50 μm to >250 μm or in the range from <5 mm to >1000 mm, respectively.

In particular, laser parameters can be set/selected such that a range in which plasma generation can take place (also referred to as ignition range), for example over a length in the range of about 5 mm to about 50 mm, for example over a length of 10 mm, 20 mm or 30 mm, extends along the beam axis 5A.

FIG. 3 schematically shows a focal zone 11A elongated along the beam axis 5A, as it is formed in the area of the surface 7A of the sample 7. The plasma 3 is formed due to the interaction of the laser radiation with the material at the surface of the sample 7A. In LIBS, the usual dimensions (averaged diameter) of a plasma 3 are in the range of, for example, 0.1 mm to 5 mm (depending on the sample material and laser parameters).

The spectrometer system 1 also includes an optical spectrometer 13 for spectral analysis of the plasma light 3A. The optical spectrometer 13 is shown in FIG. 2 as an example of a grating spectrometer. In general, the spectrometer 13 comprises at least one dispersive element 13A, e.g. a grating, a prism or a grating prism, and a pixel-based detector 13B, on which the plasma light is incident in a spectrally expanded form. The spectral components of the plasma light 3A to be analyzed are assigned to the pixels of the detector 13B. The detector 13B outputs intensity values of the irradiated pixels to an evaluation unit 15, usually a computer with a processor and a memory. The evaluation unit 15 outputs a measured spectral distribution 17 and compares this, for example, with stored reference spectra in order to assign to the plasma light 3A and thus the examined sample 3 the elements contributing to the plasma light 3A and to output them as the result of the spectral examination.

In the spectrometer 13, a (spectrally dependent) beam entrance for the plasma light to be analyzed is defined by an entrance aperture 19, usually an entrance slit 19A.

The spectrometer system 1 further comprises a detection unit 21 with an objective holder 23 and several objectives 25A, 25B, 25C, which are supported by the objective holder 23.

As an example, three objectives are shown in the Figures, two in the image plane and one behind it. The number of objectives used can be selected depending on spatial and optical parameters and parameters of the material of the sample to be examined; it is in the range of 2 to 20, for example 4, 5, 8, 9 or 15 objectives.

The spectrometer system 1, in particular the detection unit 21, further comprises an optical fiber system 27 that optically connects the objectives 25A, 25B, 25C to the spectrometer 13. The optical fiber system 27 provides several optical inputs 29, each of which is optically assigned to one of the objectives 25A, 25B, 25C, and an optical output 31 (which is functional and common to the objectives), which is optically assigned to the entrance aperture 19.

Each of the objectives 25A, 25B, 25C is configured to detect a measurement component 33 of the plasma light 3A and comprises at least one focusing optical element, such as a converging lens or a concave mirror. A detection cone 35 is assigned to each of the objectives 25A, 25B, 25C. The beam axis 5A runs through the detection cones 35, the detection cones 35 having a set minimum size in the region of the laser beam 5. Each of the detection cones 35 encompasses a plasma detection area 39 in a region of overlap with the laser beam 5, which plasma detection area 39 is assigned to the corresponding objective 25A, 25B, 25C. For example, the detection cones 35 have a length of an entrance aperture of an objective to the laser beam in the range of 200 mm to 400 mm. As an example, in FIG. 2 the plasma 3 is generated in the plasma detection area 39 of the objective 25B, so that the associated measurement component 33 of the plasma light 3A is detected by the objective 25B and imaged onto the associated optical input 29 of the optical fiber system 27. The measurement components 33 captured by one or more objectives are directed by the optical light-guiding system 27 to the common optical output 31 and coupled through the entrance aperture 19 into the optical spectrometer 13 for spectral analysis.

FIG. 3 shows three objectives 25A, 25B, 25C as an example, which are arranged azimuthally distributed around the beam axis 5A. The objectives 25A and 25B are located on opposite sides of the beam axis 5A and are thus directed onto the beam axis 5A from opposite sides. The objective 25C is directed onto the beam axis 5A from behind. Another objective (not shown in FIG. 2) can, for example, be directed onto beam axis 5A from the front or, with the aid of a beam splitter, along the beam axis 5A onto the focal zone 11A. For the sake of clarity, the detection cones 35 are indicated in FIG. 2 as running conically to the beam axis 5A, with the focal zone 11A, the plasma 3 and the plasma detection areas 39 being shown oversized in comparison to the detection cones 35 for the sake of clarity.

FIG. 4 shows once again a detailed view of the system 100 according to the invention in accordance with FIG. 1. It can be seen here that pieces of material different in their composition are provided, namely pieces of material 120B made of plastic and pieces of material 120A made of aluminum. In the manner already described, the spectrometer system 1 according to the invention can be used to sort the pieces of material 120A from the pieces of material 120B. For this purpose, the sorting unit 160 ejects a piece of material 120B made of plastic if it is detected. For this purpose, the sorting unit 160 has an air pressure nozzle 400, by means of which a plastic piece 120B can be ejected from the stream of pieces of material. As a result of such sorting, plastic pieces of material 120B and aluminum pieces of material 120A accumulate separately at the collection points 170.

FIG. 4 shows a mounting plate 23A of the detection unit 21 of the LIBS system to clarify the arrangement and orientation of the objectives 25A, 25B, 25C. For fixed mounting of the objectives, the mounting plate 23A has objective holdering holes for receiving the objectives 25A, 25B, 25C. The objective holdering apertures are each arranged at a radial distance from the beam axis 5A and are designed for an oblique orientation of the objectives 25A, 25B, 25C to the beam axis 5A.

As indicated in FIG. 4, the plasma detection areas 39 together form a viewing region 41 of the detection unit 21. The viewing region 41 extends along the beam axis 5A in the region of the focal zone 11A.

Furthermore, an optical passage opening 43 can be seen in the mounting plate 23A in FIG. 2, which is used to direct the laser beam through the holder 23 and past the objectives 25A, 25B, 25C onto the sample 7.

FIG. 5 shows a perspective view of an example LIBS measuring head that is connected to a laser beam source via an optical fiber 9A. The holder 23 of the LIBS measuring head includes a longitudinal support plate 23B, on which a fastening for the optical fiber 9A and the focusing optics 11 (laser head with beam shaping) is provided on the input side. Furthermore, the optical spectrometer 13 is attached to the longitudinal support plate 23B, and the mounting plate 23A for four objectives 25A, 25B, 25C, 25D (generally an n>1-fold input optics) is provided. The objectives 25A, 25B, 25C, 25D are designed to detect measurement components of plasma light from plasma detection areas 39 that are arranged along the beam axis 5A offset from one another, and to supply them via the optical fiber system 27 (for example, a fiber bundle with n>1 inputs and one functional output-“n-to-1 fiber bundle) to the spectrometer 13 for spectral analysis. As an example, FIG. 3 shows optical fibers 45 of the optical fiber system 27 which optically connect the objectives to the common spectrometer 13. With the optical fiber system 27, the measurement components in the spectrometer 13 (or optionally before coupling into the spectrometer 13) can be combined for a measuring process.

FIG. 6 shows a schematic side view of part of the module according to FIG. 5, in which the mounting plate 23A is equipped with a protective housing 300 according to the invention.

As can be seen from the illustration according to FIG. 6, the protective housing 300 is a frustoconical tube section. This extends along the beam axis 5A of the laser beam 5, starting from the mounting plate 23A, up to the viewing region 41, that is to say, up to the first plasma detection area 39 in the direction of propagation of the laser beam 5. By means of the protective housing 300, the distance between the plasma detection area 39 and the mounting plate 23A in the longitudinal direction of the laser beam 5 is substantially bridged.

The protective housing 300 surrounds both the laser beam 5 and the detection cones 35 that are each assigned to the objectives 25A to 25D. The laser beam 5 and the detection areas 35 are therefore enclosed by the protective housing 300.

The protective housing 300 essentially achieves two effects. Firstly, the lenses 25A to 25D, like the optical passage opening 43 formed in the mounting plate 23A for the laser beam 5, are protected against the unwanted influence of dust and/or other foreign particles originating from the environment. This largely prevents unwanted impact on the lenses 25A to 25D and the passage opening 43 by dust and/or other foreign particles.

On the other hand, the volume space provided by the protective housing 300 and traversed by both the laser beam 5 and the detection cones 35 in the intended use is also kept free of dust and/or other foreign particles, so that both the laser beam 5 and the detection cones 35 are unimpaired in their intended function.

The protective housing 300 is connected to a compressed air unit not specifically shown in the Figures. By means of this unit, compressed air can be supplied to the protective housing 900 on the mounting plate side, which compressed air flows through the protective housing 300 in the direction of propagation of the laser beam 5. As a result of such an air flow, any dust and/or other foreign particles are effectively prevented from entering the protective housing 300 via the outlet opening 303 of the protective housing 300 on the plasma detection side.

Applying air to the protective housing 300 also has the advantage that an air cone or an air column 301 is formed on the outlet side of the protective housing 300, enveloping the laser beam 5. This has the positive effect that the viewing region 41, which is composed of the plasma detection areas 39, is also kept largely free of dust and/or other foreign particles.

FIG. 7 shows a detail of the protective housing 300 according to the invention in a partially cut side view. As can be seen in particular from this representation, the protective housing 300 is frustoconical and provides the outlet opening 303 on the output side. This is preferably circular in cross-section and is traversed in the center by the laser beam 5.

The protective housing 300 is preferably made of plastic, with minimal to no reflection properties. Any stray light entering the protective housing 200 via the outlet opening 303 is absorbed to such an extent that the optics covered by the protective housing 300 are not affected by reflecting stray light. In this context, it is also intended to roughen the inner surface 303 of the protective housing 200. This leads to a diffuse reflection of stray light penetrating the protective housing, which also helps to minimize unwanted impairment of the lenses 25A to 25D covered by the protective housing 300.

FIG. 8 shows, in a purely schematic representation, the design and arrangement of a compressed air nozzle 400 according to the invention.

As can be seen from FIG. 8, the compressed air nozzle 400 is arranged at a distance from a laser beam 5 generated by the laser device 140 in the direction of movement 401 of a piece of material 120 passing the laser beam 5. This distance A between the laser beam 5 and the center of the outlet opening 402 of the compressed air nozzle 400 is less than 10 cm. However, a distance A of 6 cm to 3.5 cm is preferred, and even more a distance of 5 cm to 4 cm.

The opening diameter of the outlet opening 402 of the compressed air nozzle 400 is, according to the invention, greater than 3 mm and is preferably 6 mm to 7 mm, most preferably 6.5 mm.

The compressed air nozzle 400 is supplied with compressed air from a compressed air generator 405.

The compressed air nozzle 400 is designed to be switchable, for which purpose a solenoid valve 403 is provided. This is in fluidic connection with the compressed air generator 505 on the one hand, via the line 406, and with the compressed air nozzle 400 on the other hand, via the line 404.

The structural separation of the compressed air nozzle 400 and the solenoid valve 403 makes it possible to use the installation space in the immediate vicinity of the laser device 140 in an optimized manner to position the compressed air nozzle 400 as close as possible to the laser beam 5, that is, to select the distance A in the manner already described.

Reference signs

| | |
|---|---|
| 1 spectrometer system | 111 feeding means |
| 3 plasma | 120 piece of material |
| 3A plasma light | 120A aluminum part |
| 5 laser beam | 120B plastic part |
| 5A beam axis | 130 chute |
| 7 sample | 131 upper section |
| 7A surface | 132 lower edge |
| 9 laser beam source | 140 laser device |
| 9A optical fiber | 150 control device |
| 11 focusing optics | 160 sorting unit |
| 11 focal zone | 170 accumulation point |
| 13 optical spectrometer | 180 LIBS module |
| 13A dispersive element | 200 conveyor |
| 13B detector | 201 feeding unit |
| 15 evaluation unit | 202 feeding unit |
| 17 spectral distribution | 203 feeding unit |
| 19 entrance aperture | 204 feeding surface |
| 19A entrance gap | 205 feeding surface |
| 21 detection unit | 206 feeding surface |
| 23 objective holder | 207 transport direction |
| 25A objective | 300 protective housing |
| 25B objective | 301 air column |
| 25C objective | 302 inner surface |
| 25D objective | 303 outlet opening |
| 27 optical fiber system | 400 compressed air nozzle |
| 29 optical input | 401 direction of movement |
| 31 optical output | 402 outlet opening |
| 33 measurement component | 403 solenoid valve |
| 35 detection cone | 404 line |
| 39 plasma detection area | 405 air pressure generator |
| 41 viewing region | 406 line |
| 100 system | |
| 110 feeding means | |
| α₁ inclination angle | |
| α₂ inclination angle | |
| α₃ inclination angle | |

1. A system for analyzing and sorting a piece of material, in particular a piece of aluminum scrap, the system comprising:
a feeding means for transporting the piece of material,
a sorting unit that is configured to feed the piece of material into one of two fractions.
a laser device that is configured to generate a plasma on a surface of the piece of material using a laser beam propagating along a beam axis,
a spectrometer system that is configured to perform a spectral analysis of a plasma light emitted by the laser-induced plasma and to generate an output signal in accordance with a result of the spectral analysis performed, and
a control device that is configured to receive the output signal and to operate the sorting unit based on the output signal and a sorting criterion,
the spectrometer system comprising a spectrometer and a detection unit optically connected to the spectrometer,
wherein the detection unit has an objective having a detection cone assigned to it which, in an overlap region with the laser beam, forms a plasma detection area,
wherein the feeding means comprises three individual feeding units arranged in series one behind the other in the direction of transport of the piece of material,
wherein each feeding unit is respectively configured to transport the piece of material along a feeding surface provided by the respective feeding unit,
wherein the feeding surfaces are each inclined relative to the horizontal, forming a respective angle of inclination (α₁, α₂, α₃),
wherein the angles of inclination (α₁, α₂, α₃) are differently designed, wherein
that the angle of inclination (α₁) of the feeding surface of the first feeding unit in the direction of transport is configured to be smaller than the angle of inclination (α₂) of the feeding surface of the second feeding unit in the direction of transport, and
that the angle of inclination (α₂) of the feeding surface of the second feeding unit in the direction of transport is smaller than the angle of inclination (α₃) of the feeding surface of the third feeding unit in the direction of transport.

2. The system according to claim 1, wherein the difference between the angles of inclination (α₁, α₂, α₃) is 2° to 8°, preferably 3° to 7°, most preferably 5°.

3. The system according to claim 1, wherein the angle of inclination (α₁) of the feeding surface of the first feeding unit in the direction of transport is 7° to 13°, preferably 8° to 12°, most preferably 10°.

4. The system according to claim 1, wherein the angle of inclination (α₂) of the feeding surface of the second feeding unit in the direction of transport is 12° to 18°, preferably 13° to 17°, most preferably 15°.

5. The system according to claim 1, wherein the angle of inclination (α₃) of the feeding surface of the third feeding unit in the direction of transport is 17° to 23°, preferably 18° to 22°, most preferably 20°.

6. The system according to claim 1, wherein the angles of inclination (α₁, α₂, α₃) are designed to be adjustable.

7. The system according to claim 1, wherein the first feeding unit [(201)] in the direction of transport is a vibration conveyor with an unbalanced drive.

8. The system according to claim 1, wherein the second and third feeding units in the direction of transport are each an oscillating conveyor with a magnetic drive.

9. The system according to claim 1, wherein the detection unit comprises a further objective having assigned to it a further detection cone which forms a further plasma detection area in a further overlap region with the laser beam, the objectives being arranged and/or aligned in relation to one another in such a way that the plasma detection area and the further plasma detection area are arranged offset along the beam axis and together form a viewing region of the detection unit.

10. The system according to claim 1, wherein a plasma detection area is configured such that, in the event of a plasma being present in the plasma detection area, a measurement component of the plasma light is detected by the associated objective.

11. The system according to claim 1, wherein the plasma detection areas are arranged such that they merge into one another or are spaced apart from one another along the beam axis.

12. The system according to claim 1, wherein the objective holder provides an optical passage opening through which the beam axis extends.

13. The system according to claim 1, wherein the sorting unit is assigned to a lower edge of the chute, which lower edge is located opposite an upper section of the chute, the sorting unit being configured to feed the piece of material leaving the chute via the lower edge of the chute to one of two fractions.

14. The system according to claim 1, wherein the detection unit carries a protective housing that surrounds the laser beam and the detection cone, the protective housing extending along the beam axis.

15. The system according to claim 1, wherein the sorting unit comprises a compressed air nozzle with an outlet opening diameter of greater than 3 mm, preferably from 5 mm to 8 mm, wherein the compressed air nozzle is arranged at a distance from a laser beam generated by the laser device in the direction of movement of a piece of material passing the laser beam, wherein the distance between the laser beam and the center of the outlet opening of the compressed air nozzle is greater than 10 cm, preferably between 8 cm and 3 cm.
